(19) United States
(12) Patent Application Publication
(10) Pub. No.: US 2004/0054613 A1
(43) Pub. Date: Mar. 18, 2004

(54) System and method for depositing and investing illiquid or restricted assets

(76) Inventor: Maynard L. Dokken, Vancouver (CA)

Correspondence Address: Paul Smith Intellectual Property Law, 330-1508 West Broadway, Vancouver, BC, V6JIW8, CA

(21) Appl. No.: 10/426,013

(22) Filed: Apr. 30, 2003

Related U.S. Application Data
(60) Provisional application No. 60/376,196, filed on Apr. 30, 2002.

(51) Int. Cl. G06F 17/60

(52) U.S. Cl. 705/36

(57) ABSTRACT

This invention relates to the deposit or investment of illiquid or restricted assets. It further relates to the deposit or investment indirectly or directly of these assets into an investment fund. The securities of the fund are invested with or loaned to institutions under terms that provide liquidity for the securities. For example, an insurer may rely on the assessed value of such securities to support margin requirements. Guarantees or bonds may be provided to insure against loss of principal of the fund's investment. A base risk margin database calculates the risk of loss to determine a cost of the guarantees or bonds. The owner of illiquid or restricted assets is thereby able to receive a liquid or monetary return on the assets while the borrowers of fund's securities are provided with a variety of financial tools.

### CROSS-REFERENCE TO RELATED APPLICATIONS

The applicant herein claims domestic priority benefits from U.S. Provisional Patent Application No. 60/376,196 entitled System and Method for Investing Illiquid or Restricted Assets, filed Apr. 30, 2002.

### FIELD OF THE INVENTION

The invention relates to illiquid or restricted assets. In particular the invention relates to the deposit or investment of illiquid or restricted assets. The illiquid or restricted assets can be deposited or invested and the owner can receive a return on these illiquid or restricted assets. The return can be in any structure or form including fixed or variable.

### BACKGROUND OF THE INVENTION

Illiquid or restricted assets can include small and mid-size company loans, insurance contracts, young-company equity and debt, pensions, and real estate loans. They also include real property or physical assets such as cars, homes, commercial buildings, boats, furniture and art. Illiquid or restricted assets are usually held personally and in companies.

Those holding such assets would typically appreciate having them generate a return. Such assets can sometimes achieve a form of liquidity with short term loans or through pawnbrokers or other short term lenders, but at very high rates. Banks and other financial institutions collateralize these assets and provide liquidity in the form of cash or credit to their customers through the issuance of their own liabilities and equity. These assets traditionally depreciate without any real return.

Illiquid assets are sometimes used in other ways. Pledges of assets that probably include illiquid assets have been used to underwrite risks in the insurance business. People who joined Society of Lloyd's to underwrite insurance risks were referred to as “names.” The Lloyds names, roughly 30,000 world-wide, cover out of their own pockets insurance claims against the Lloyd's syndicates to which they belong. These names join a syndicate and pledge their assets against potential claims.

Reverse mortgages offer consumers a type of home equity loan that allows them to convert some of the equity in their home into cash while retaining home ownership like traditional mortgages only in reverse. Rather than making a payment to a lender each month the lender pays them in return for their equity.

Hedging art derivatives provide art owners a method to protect against falls in the value of art works through the use of options based on an index. For example if an art portfolio shows a negative return, the art collector is not obliged to make a loan payment but receives a payment to compensate for the loss in art value.

Repurchase agreements provide dealers in government securities, which are sold weekly, a method to buy securities valued greater than their net worth. The dealer pays the government for a portion and enters into a repurchase agreement for the balance. The bond dealer agrees to sell the unpaid balance back to the government with the understanding that he can repurchase them in the future. When the dealer buys the securities back from the government the dealer pays the government interest.

In an Up/Down REIT's individuals and/or partnerships owning real estate contribute their holdings to an umbrella partnership in exchange for limited partnership units. A REIT is formed and issues shares to the public and the REIT contributes the proceeds received from the REIT shareholders to the umbrella partnership in exchange for a general partnership interest.

Markets provide financial products and services such as options, futures, and indexes to allow their participants or customers to manage risks or create business opportunities. These products allow these market participants or customers to purchase an instrument which follows a particular index or projects a lower or higher value of the securities or commodities to offset their positions or risk.

As the preferred embodiment of the invention contemplates the use of an investment fund, some background in relation to such funds follows.

Investment funds are vigorously regulated and must comply with a large number of laws and regulations. Investment funds offering their shares to the public usually are required to register them pursuant to Securities Acts and provide notice of filings to those jurisdictions in which they intend to offer their shares. Those who sell fund shares to the public are normally subject to regulation as broker-dealers, while investment advisers to funds generally are required to register under the Investment Advisers Act.

A cost-effective way to invest and to manage risk without hiring your own professional adviser is investing into a fund, which is pooled resources of thousands of shareholders managed by a professional investment adviser, who invests the fund in a much larger number of securities. The investors are the owner of the funds and entitled to income and gain from its investments less administrative fees.

A professional adviser manages diversification of risk by investing into many types of investments with different objectives and returns. The securities have many options such as common stocks, bonds, governmental obligations, and money market funds including certificates of deposit, commercial paper and government treasury bills.

Detailed requirements on the structure and operations of investment funds are governed under laws as corporations or trusts. Investment funds are managed by third parties such as investment managers, broker-dealers, and banks. Investment funds normally allocate their shares through separate companies designated as the funds' principal underwriters. It is necessary to buy back their outstanding shares at any time upon a shareholder's request, at a price based on the current value of the fund's assets.

Different classes of shares can be structured using several retail classes, with different combinations of front and back end sales charges and fees. Other classes may be structured to accommodate the needs of institutional investors such as banks and trust companies or needs of their individual beneficiaries. The portfolio of different classes of shares characterize by the same ownership.

Investment funds incorporate different classes of “management companies” such as classified “diversified” or “non-diversified”. A diversified company has at least 75 percent of the value of its total assets in cash and cash items (including receivables), government securities, securities of other investment companies, and other securities in condition of any one issuer to an amount not greater in value than 5 percent of the fund's total assets and not more than 10 percent of the outstanding voting securities of such issuer.

The third party administrator of the investment funds may be an affiliate or unaffiliated. The administrator supervises the performance of other companies that provide services to the fund, compliance with applicable federal requirements.

Investment funds are sub-classified as open-end investment companies in many jurisdictions and redeem their shares at any time upon shareholder request. Within 7 days after receiving the shareholder's request, the fund needs to pay redeeming shareholders a price based on the net asset value of the fund's investment portfolio. Closed-end investment companies do not redeem their shares; shareholders who wish to dispose of their shares normally sell them in the open market, on stock exchanges, at a price agreed on by the buyer and the seller.

The portfolio of the investment fund must be protected in the custody of a qualified and secured party such as bank custodians. The portfolio of the investment fund is separate from the rest of bank's assets and the bank custody agreement for the investment fund is very detailed. It is a requirement to receive instructions by on officer of the funds to make any transactions of the fund. Investing in foreign securities engages much other contemplations such as foreign laws, the custodian's records, lost securities, and insolvency by the custodian.

The daily records of shareholder accounts transactions must be maintained by a funds transfer agent. The duties of the transfer agent are shareholders account statements, federal income tax information, other shareholder notices, calculation and recording of dividends and authorizing payment by the custodian.

Investment fund shares are sold at brokers, discount brokers, banks, insurance companies, or investment fund companies themselves.

The investment funds have flexible options for the different needs of investors. The options can be different fee structures, different classes of shares or different structures of funds through a master/feeder structure. A master/feeder structure presents different funds structures and different fee structures as well as other features appropriate to its particular market. Each of these “feeder” funds invests its assets in another fund, termed the “master” fund. The master fund invests those assets in the securities markets.

Investment funds maintain an “evergreen” prospectus, register an open-ended number of shares and pay a registration fee based on the actual sold shares after the end of each fiscal year, to initiate continuous offering of shares.

Lloyds syndicates, mutual funds, deposit brokers, reverse mortgages, hedging derivatives, and Up/Down REITs provide mechanisms for cash investment, sale or mortgage of equity, or hedging of value but do not provide a method for individuals or corporation to invest, deposit and withdraw individual assets, particularly illiquid or restricted assets. Banks provide loans for illiquid and restricted assets but they will not take these assets as a deposit and provide interest.

### SUMMARY OF THE INVENTION

One of several aspects of the present invention is to create a method where holders of illiquid or restricted assets can receive a return on their assets.

The invention provides for the placement of these illiquid or restricted assets directly or indirectly in a trust, account, fund or investment vehicle. Customers may open a reverse investment fund, trust or account at a variety of originators including banks, insurance companies, investment fund companies and retail and commercial businesses. Such accounts may be opened electronically over the Internet.

The reverse investment fund takes ownership or a pledge of illiquid or restricted assets directly or indirectly (as opposed to accepting cash from the fund shareholders and purchasing securities or other assets as investments as is traditionally done by investment funds).

The original owners of the illiquid or restricted assets subscribe to shares in the reverse investment fund directly or indirectly. They may also pledge their shares to the reverse investment fund as payment, so as to make those shares an asset of the fund. It is the lending or investment of the shares or assets in the fund that provides a return.

The reverse investment fund can continually receive new illiquid or restricted assets directly or indirectly through a trust or fund account and issue securities based on the value of these assets.

The reverse investment fund is designed to permit thousands of illiquid and restricted asset owners to pool their resources in a fund that in turn invests or lends the fund's shares or securities in selected investments made by a professional investment adviser.

The reverse investment fund returns the fund's income, gain or loss from the investment, lending and pledge of assets, net of fees and other operating expenses to the reverse investment fund and through it to the illiquid and restricted asset holders directly or indirectly through a trust or fund account.

The invention provides for a method of management through the use of database and business management software for reverse investment funds.

In one aspect, the invention contemplates providing a comprehensive risk analysis database which is called a Base Risk Margin Database. This actuarial database collects risk profiles of all issuances of securities from the reverse investment fund and the potential risk of default for these securities. The database may also do so for a variety of related or unrelated funds. The database also receives risk profiles on issuances of related loans, guarantees, underwritings or other financial instruments or obligations as a result of the lending of securities, securities pledges or other financial instruments or investments of the reverse investment funds.

An insurance bond or principal guarantee can then be issued by an insurer based on the risk of loss for the reverse investment fund investments calculated by the Base Risk Margin Database. The bond or guarantee insures the illiquid or restricted asset or fund against loss of the investment, inability to withdraw assets from the trust, account, and investment vehicle or in the event of bankruptcy, thereby providing a basis for liquidity of the fund shares.

A cost for the principal guarantee coverage can be established based on these overall risk factors. This database information can be used to evaluate the actuarial analysis of all issuances of financial guarantees or instruments for all reverse investment funds.

The Base Risk Margin Database provides risk profiles and ratings of all financial participants in the reverse investment fund including the illiquid or restricted asset owners. It also tracks and independently rates the funds, the borrowers and any financial instruments issued directly or indirectly by reverse investment funds.

A designated financial institution or services company could provide a repurchase agreement, liquidity bond or conditional financial instrument such as a conditional letter of credit to repurchase the shares or securities pledged from the reverse investment fund. This provides further liquidity or credit enhancement for the shares or securities issued by the reverse investment fund.

The reverse investment funds may be designed for many different types of illiquid and restricted assets and for many different types of investment objectives.

The different investment objectives will range from maximizing total return to providing the highest level of income consistent with the preservation of illiquid or restricted owner's assets. To achieve their objectives, funds will invest or loan the funds shares or securities in a wide variety of commercial, financial and money market related industries and programs. The reverse investment fund may require the illiquid or restricted assets to be pledged directly, indirectly or otherwise secured to the fund for set periods of time as well as other terms and conditions.

The fund may monetize or use the shares to support a credit line and use this credit to invest in securities or other financial instruments or strategies in the marketplace. This provides many different fund strategies or profiles as diverse as current mutual and hedge funds.

The illiquid or restricted assets profiles or funds data can be used for futures, options, market indexes or as similar instruments to provide a diverse array of strategies to build market products or services.

The reverse investment funds can be organized as corporations, business/statutory or any legal form of trust.

A fund manager develops strategies and structures for reverse investment funds including associated terms of repurchase agreements and related insurance, surety bonds and guarantees.

A fund originator manages the overall creation and opening of the illiquid or restricted asset owners, trust or fund accounts. Based on the criteria set by the fund manager the originator establishes a fair market value or liquidated value of the invested assets. The fund originator can sell related services such as corresponding loans or credit guarantees based on the liquidated value of the assets invested in the trust or fund account. The originator can also provide income, employment, illness and injury coverage based on the illiquid or restricted assets value.

A trustee usually serves as a disbursing agent, and their duties involve calculating returns, authorizing payment by the custodian, maintaining payment records, and providing securities lending services. They prepare and mail annual account statements, income tax information, and other notices. In many cases the trustee also prepares on behalf of the fund statements confirming transactions and reflecting balances.

A reverse investment fund transfer agent and or asset registry is required to maintain a record of customer's accounts or assets, which reflect customer's pledges, redemptions, account balances, fair market and liquidated value. The asset registry provides verification that illiquid or restricted assets have not been pledged or deposited more than allowed by regulation, policy and law.

The reverse investment fund incurs costs related to advertising, distribution of information, data services, compensation of sales personnel, and general overhead. Some originators may bear these costs out of their own profits. Others may offset the costs by collecting a fee from the fund or a sales load from the fund's customers. A front-end load is a fee paid by the customers when they open an account. A back-end load is a fee charged when illiquid or restricted assets are redeemed early and may reduce progressively the longer the customer has the illiquid or restricted assets in the reverse investment fund. A fund may also expend a small portion of its assets to pay expenses. The reverse investment fund may employ these methods in combination, such as a small front-end sales load and an ongoing fee.

The reverse investment funds can be a hedge fund. The reverse investment funds or reverse hedge fund can be sub-classified as open-end reverse investment funds which redeem their customer's assets back to them at any time upon customer request but will likely require them to pay a fee. A closed-end reverse investment fund requires the customer's assets to be invested for a specific period of time. Customers who wish to redeem their assets or shares usually must sell their rights in the open market. Shares of closed-end reverse investment funds may be listed on stock exchanges.

Different groups of customers such as individuals and various types of institutions have different service needs and may require different fee structures. To accommodate these differences, reverse investment funds may offer different classes of shares, securities or offers through a master/feeder structure.

The reverse investment funds can be individual, master or master/feeder. The individual reverse investment fund is designated for investments which are made in the name of natural persons.

Under a master/feeder structure, several different feeder reverse investment funds are offered, each of which has a fee structure and other attributes appropriate to its particular market. Each of the feeder funds pledges or exchanges its shares or securities with a master reverse investment fund, termed the master fund. The master fund, in turn, invests the master reverse investment funds assets.

The funds shares or securities can be loaned or invested to support margin or solvency requirements for financial institutions or services companies. The financial institutions or services companies such as an insurance company would receive the shares along with a collateralization or investment agreement for return on the investment. For example, these may support the issuance of policies as margin for unpaid claims and unearned premiums.

In order to facilitate the continuous offering of shares, a master reverse investment fund may maintain an evergreen prospectus and register an indefinite number of shares. After the end of each fiscal year the master reverse investment fund may be required to pay a registration fee based on the shares outstanding.

The borrowing financial institution or services company may become a member or register with a reverse investment fund information or collateral exchange. This exchange provides an open market to borrow shares or securities which would have different terms, conditions and profiles. This exchange would have reverse investment fund shares or securities which could have different periods of investment based on the maturity date of the fund or its fund or trust accounts. The borrowing entity, financial institution or services company will have a selection of different funds shares or securities based on its rating. They would also have available different types of repurchase, lending or conditional financial instruments and insurance for each transaction based on the borrower, lender and securities credit profile and ratings. They would also have access to letters or credit, liquidity bonds or other financial instruments to further support liquidity of the borrowed or invested shares or securities.

Other aspects of the invention will be appreciated by reference to description of the preferred embodiment and to the claims that follow.

### BRIEF DESCRIPTION OF THE DRAWINGS

The preferred embodiment of the invention will be described by reference to the drawings thereof, in which:

FIG. 1 is a chart of participants in the system of the preferred embodiment;

FIG. 2 is a chart showing a system involving individual, master, master/feeder arrangements of funds;

FIG. 3 is a chart illustrating the investment of the fund's shares or securities in an insurance or financial institution;

FIG. 4 is a chart illustrating the Base Risk Margin Database;

FIG. 5 is a chart illustrating the use of a guarantee or surety bond in connection with the invention;

FIG. 6 is a chart illustrating the use of a repurchase agreement;

FIG. 7 is a chart illustrating the creation and use of asset-backed securities according to the invention;

FIG. 8 is a chart illustrating the collateral financial instruments and services that can be created using the invention:

FIG. 9 is a chart illustrating the use of an information portal according to the invention;

FIG. 10 is a chart illustrating the return to the customers.

### DETAILED DESCRIPTION OF THE PREFERRED EMBODIMENT

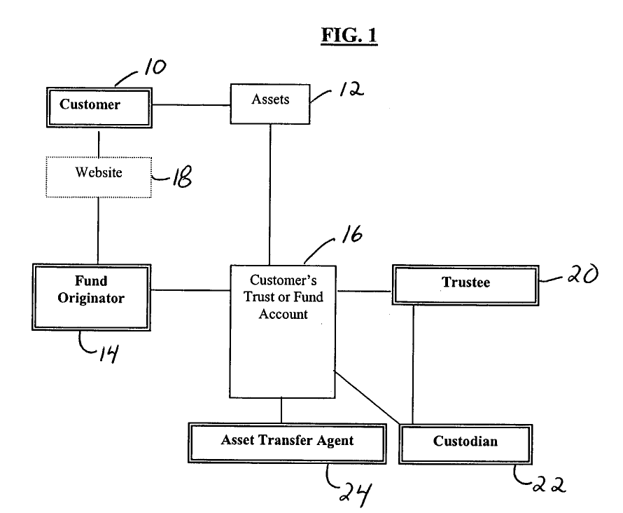

FIG. 1 illustrates some of the participants in the system of the preferred embodiment of the invention. A customer 10 is the original owner of the illiquid or restricted assets 12, and seeks a return on those assets.

A fund originator 14 manages the overall creation and opening of reverse investment fund, trust or similar accounts 16. Customers may open a reverse investment fund account at a variety of originators including banks, insurance companies, investment fund companies and most financial services related retail and commercial businesses that are licensed if required. They may also open an account electronically over the Internet. Documents, including a warranty that the assets are free and clear of encumbrances, and any insurance that may be required, may be obtained from the customer upon opening the trust or fund account.

Typically, a customer will go to a reverse investment fund corporate website 18. The website provides a list of documents required to open an account including a warranty of clear title, and an assignment or transfer of the asset(s) to the trust or fund account. The website may also provide a list of originators or agents that can process deposits or investments.

The reverse investment fund is organized as a business/statutory or any legal form of trust. The customer pledges, assigns, hypothecates or otherwise securitizes the illiquid or restricted assets to the trust or fund account for the benefit of funding the subscription of shares in the reverse investment fund.

When the customer provides the necessary documentation and opens a reverse investment fund trust or fund account, the assets are evaluated for “liquidation” and “fair market value”. This can be done through the originator 14 or a fund manager according to policies established by the issuer of the guarantee or insurance that will be sought as described below. The completed documentation is approved through a trustee 20 and the investment or assignment of assets is transferred to a custodian 22.

The trustee 20 serves as a disbursing agent, calculates returns, authorizing payment by the custodian, and maintains payment records. The trustee prepares and mails on behalf of the fund annual statements as required by statute, confirming transactions and reflecting balances.

A reverse investment fund transfer agent 24 or asset registry is required to maintain a record of customer's accounts, which reflect customer's assets, redemptions, account balances, fair market, liquidated value and is accessible to customers.

Trustees 20 and custodians 22 are accessible to the funds executives, managers and related administrative contacts. The custodian distributes payments based on the instructions from the trustee 20.

The reverse investment fund incurs costs related to advertising, distribution of information, data services, compensation of sales personnel, and general overhead. Some originators may bear these costs out of their own profits. Others may offset the costs by collecting a distribution fee from the fund or a sales load from the fund's customers. A sales load can take several different forms. A front-end load is one that the customers pay when they open an account. A back-end load is charged when illiquid or restricted assets are redeemed and may reduce progressively the longer the customer has the illiquid or restricted assets directly or indirectly in the reverse investment fund. A fund may also expend a small portion of its assets to pay distribution expenses.

The reverse investment funds are sub-classified as “open-end” reverse investment fund companies which redeem their customer's assets at any time upon customer request, but will likely require them to pay a fee. The “closed-end” reverse investment fund companies do not release their customer's assets for a specific period of time. Customers who wish to redeem their assets or sell their securities, shares generally must sell their rights in the open market. Shares of these closed-end reverse investment funds may be listed on stock exchanges.

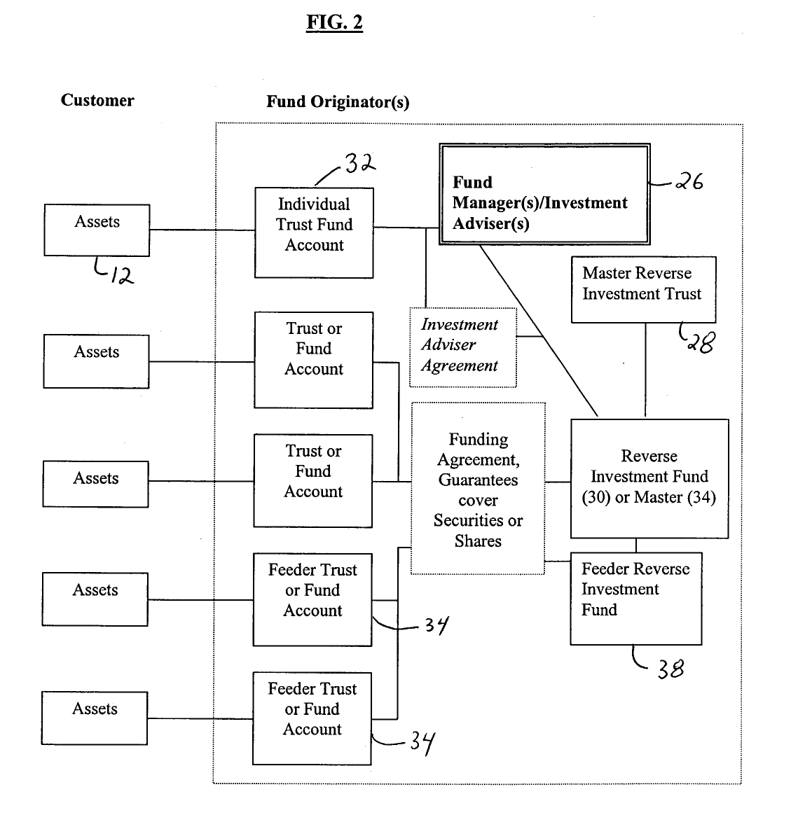

FIG. 2 is a chart showing a system involving individual, master, master/feeder arrangements of funds.

A fund manager/investment adviser 26 develops strategies and structures for reverse investment funds including associated terms of repurchase agreements and related insurance and guarantees.

The master reverse investment fund trust 28 is authorized to create any number of separate and distinct series. The master reverse investment fund 30 is a series maintain by the trust.

The reverse investment funds can be individual 32, master 34 or master/feeder 36. The individual reverse investment fund is designated for investments which are made in the name of natural persons. The master and master/feeder reverse investment funds 34, 36 are for investments which are made on behalf of or in the name of the fund.

Under a master/feeder structure, several different feeder reverse investment funds 38 are offered, each of which has a fee structure and other attributes appropriate to its particular market. Each of the “feeder” funds 34 pledges or exchanges its shares or securities with a master reverse investment fund 34, termed the “master” fund. The master fund 34, in turn, pledges or exchanges the master reverse investment shares or securities, such pledges representing the investments of the master fund. The fund can also underwrite investments of its own by using the fund shares to open a margin account for cash to be used in different investment strategies.

Each investment of the fund's shares is subject to an investment, redemption or repurchase agreement between the fund and the entity or institution in which the shares are pledged or invested. Such agreement sets out the terms under which the shares in the fund may be redeemed, repurchased or were invested by the fund.

The shares or securities of the fund can be used to support margin or solvency requirements for financial institutions or services companies. As noted above, such shares are loaned or invested in insurance companies, supporting the issuance of policies based on the use of these assets as margin for unpaid claims and unearned premiums.

Different groups of customers (e.g., individuals and various types of institutions) have different service needs and, accordingly, may require different fee structures. To accommodate these differences, reverse investment funds offer different asset classes or special purpose funds through a master/feeder structure. The fund manager 26 develops strategies and structures for reverse investment funds including associated terms of repurchase agreements and related insurance and guarantees (such insurance and guarantees are discussed below).

The master reverse investment fund is designed to permit thousands of illiquid and restricted asset owners to pool their resources in a fund which in turn invests or loans the funds assets in the form of shares, securities or guarantees in selected investments made by a professional investment adviser or fund manager.

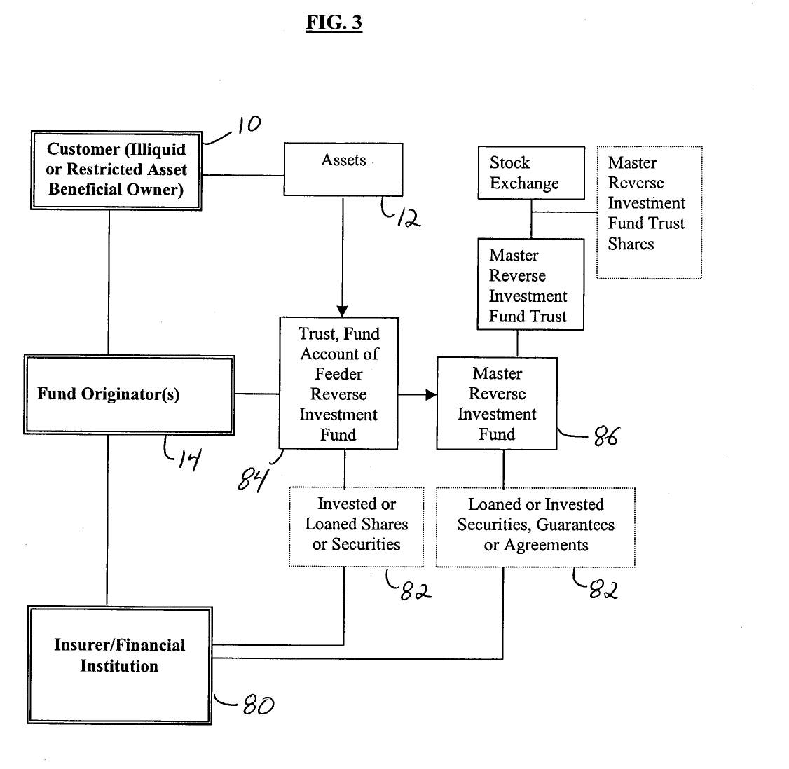

FIG. 3 illustrates one form of investment of the fund assets in an insurance or financial institution. An insurer or financial institution 80 receives invested or loaned shares, securities or guarantees 82 from a feeder 84 or a master 86 fund. The fund shares can be used to support or underwrite a credit line for the purchase of other securities as an investment strategy for the fund. The funds shares can be conditionally loaned or invested to support solvency or margin requirements for financial services companies 80 in industries such as banking and insurance.

The shares or securities of the reverse investment fund can be loaned or invested based upon a credit rating and pricing on an exchange in an on-shore or off-shore jurisdiction of the master reverse investment trust shares. A bond or guarantee of principal (i.e. the assessed value of the shares) can be used to enhance the credit rating.

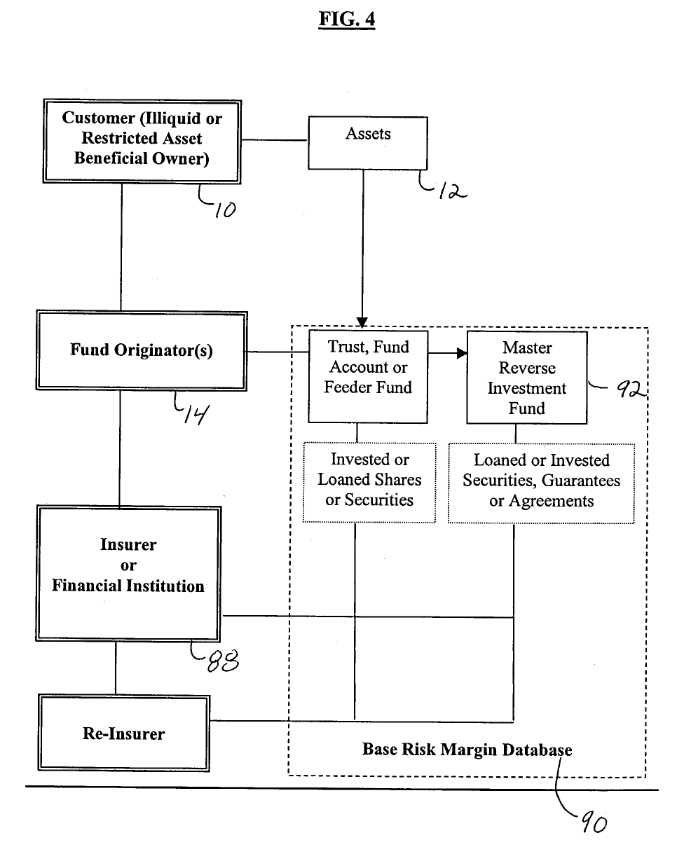

FIG. 4 illustrates the Base Risk Margin Database. The reverse investment software and base risk margin database provide a system to input various profiles and credit information for participants including: customers 10, the originator 14, fund manager 26, trustee 20, custodian 22, bank & trust, insurer 88, borrowers, lenders, and various other participants and insurers. It provides an interface to view customer as well as participants risk ratings and profiles and can be made available online to authorized users. This information would include transactional details, customer account balances, risk analysis and status of funds.

The Base Risk Margin Database 90, a comprehensive risk analysis database, receives data from all financial participants which is used to provide actuarial risk analysis and profiles of all issuances of securities related to reverse investment funds 92, and the potential risk of default for these invested, pledged or borrowed securities. The database also receives risk profiles on issuances of loans, guarantees, underwritings or other financial instruments or obligations of borrowers of the fund's shares as well as credit enhancement policies or agreements.

The Base Risk Margin Database 90 can directly or indirectly register the illiquid or restricted asset investments to provide further assurance the illiquid or restricted assets have not been pledged or otherwise invested in other trusts, fund accounts, funds or investments.

The base risk margin database “rates” the financial participants of the reverse investment funds based on: their financial strengths; external ratings from traditional rating agencies such as Moody's, Standard and Poor's and Fitch; track record of borrowed reverse investment fund securities; type of loans, underwritings, credit and other financial instruments outstanding; industry information; segments of industries and other risk management criteria.

Ratings would be similar to traditional rating agencies such as “A” or “BBB” with A being stronger than “B” and “B” being stronger than “BB”.

The base risk margin database 90 establishes insurance and re-insurance based on actuarial estimates of comprehensive potential loss risk profile in the base risk margin database. Instruments issued through the entity in which the pledged shares or securities are ultimately invested are also profiled and used to derive a separate calculation which is transmitted to the base risk margin database and is used to evaluate the total risk profile of reverse investment funds as a whole as well as individually. This information is also used to establish the costs of guarantee bonds and reverse investment fund insurance and support a cooperative or captive insurance company.

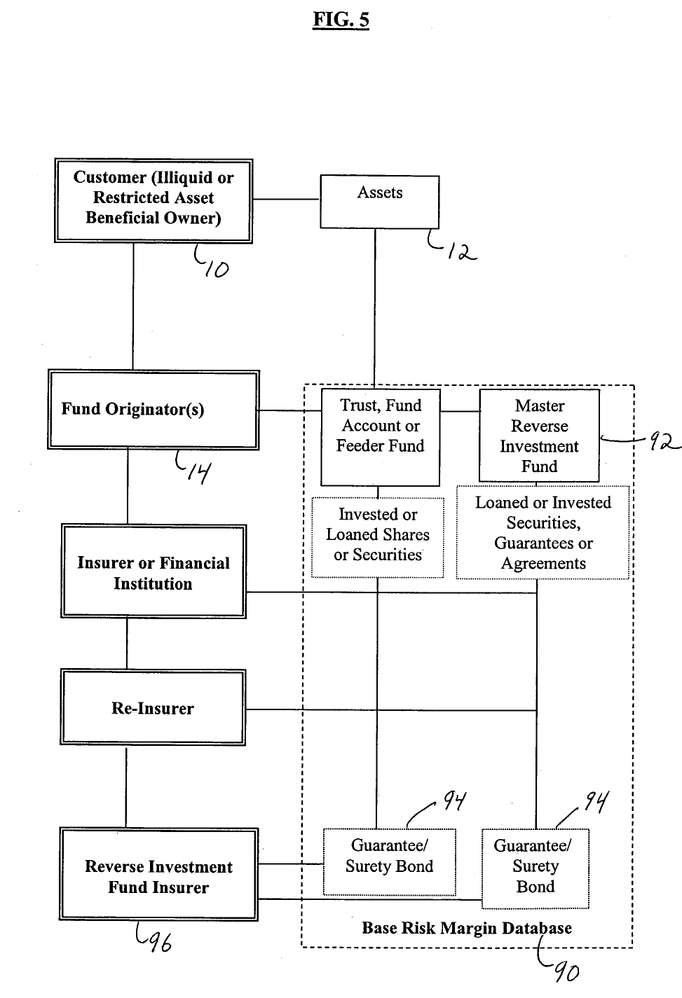

FIG. 5 illustrates the use of guarantee or surety bonds to enhance the liquidity of the fund's securities. An insurance guarantee or surety bond 94 can be issued by the insurance entity or other investment or fund insurer 96. The cost can be based on actuarial analysis of the potential investment risk of loss using calculations made based on the information in the Base Risk Margin Database 90. A cost for this coverage can be established based on overall or individual fund risk profiles.

The insurance protects the illiquid or restricted asset investor from loss of assets, bankruptcy, difficulties dissolving or closing the trust or fund account. It provides an insurance cover for the funding agreement, guarantees, securities or shares used as payment for the shares in the reverse investment fund. It also provides for the cover of loans or investments using the funds securities or shares.

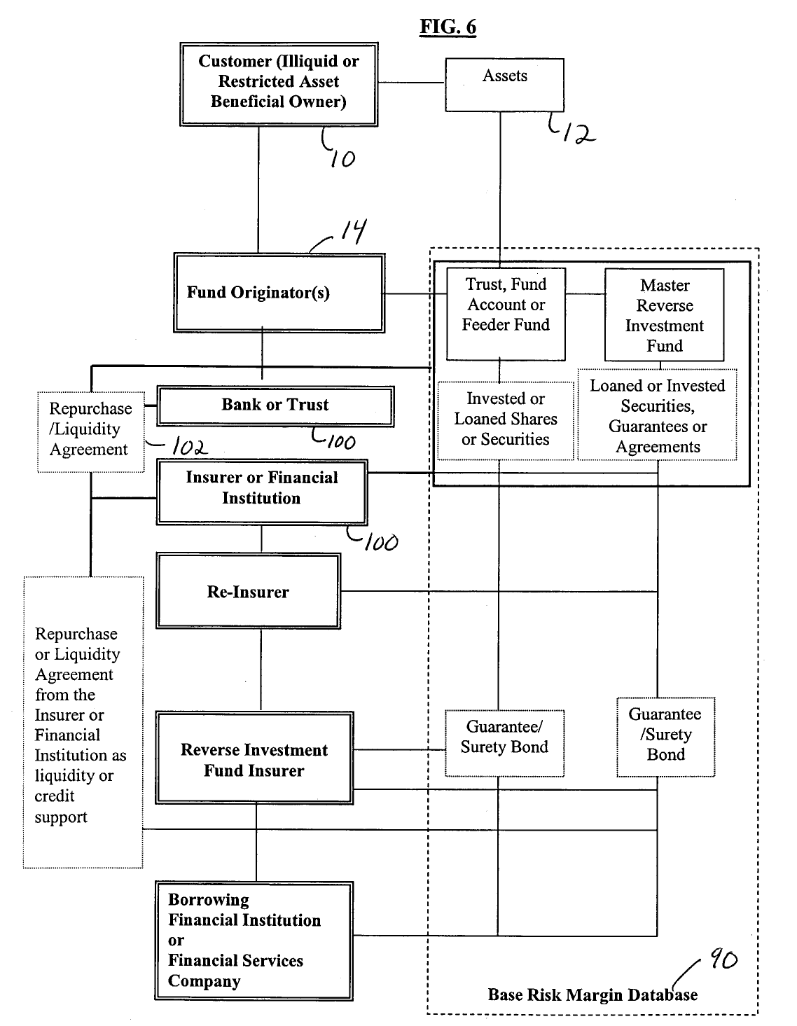

FIG. 6 illustrates the use of a repurchase agreement designed to enhance the liquidity of the fund's securities. An insurer, financial institution, company or trust 100 provides a repurchase or liquidity agreement, conditional letter of credit or similar financial instrument 102 and receives a fee or return based on the value of the assets covered. This provides a method to assure liquidity for the securities of the reverse investment fund.

These repurchase or liquidity agreements provide insured liquidity for borrowers of the funds securities or credit enhancement for invested securities. The entities in which the shares or securities are ultimately invested or loaned, i.e. the borrowing financial institutions or services companies, sign an agreement to provide risk profiles and credit rating data of each financial instrument placed, based on criteria required by the insurer or financial institution actuaries and rating agencies. This information is transmitted to the base risk margin database 90.

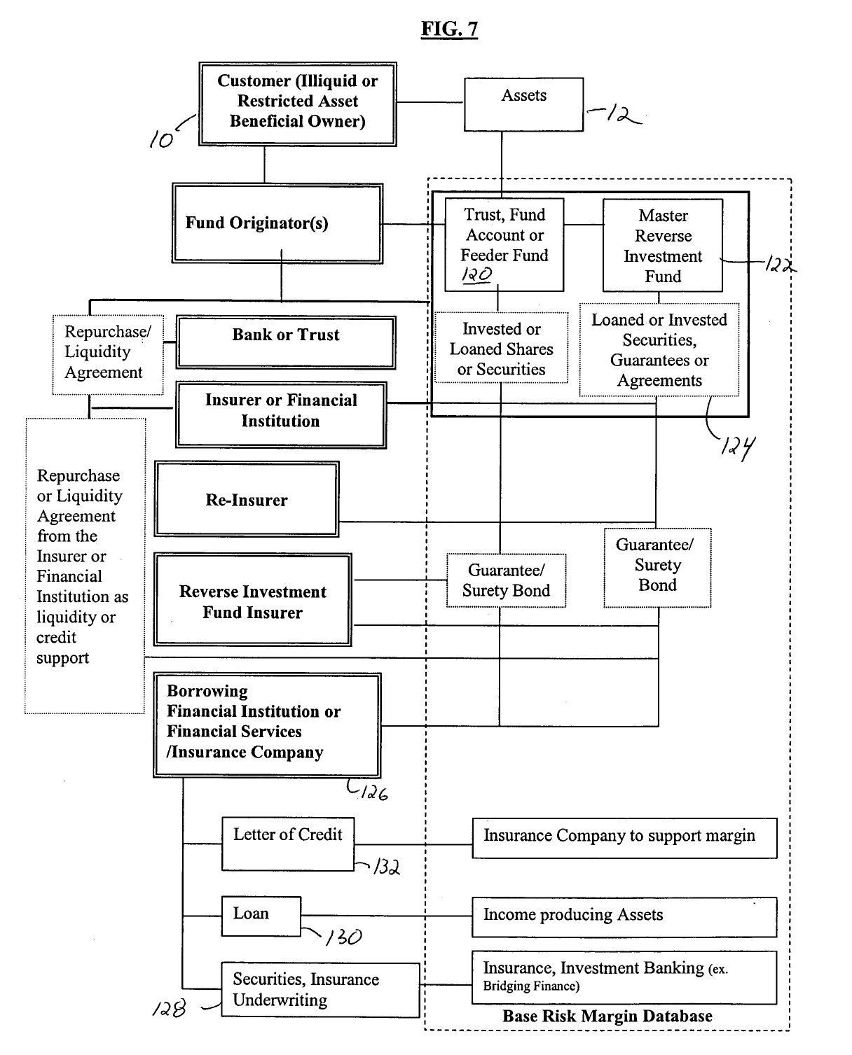

FIG. 7 illustrates the creation of asset-backed securities according to the invention. The illiquid asset owner 10 deposits or invests the illiquid or restricted assets 12 into a fund 120 through a trust. The trust then conveys theses illiquid assets to a fund 122 through a short term asset backed security. This capitalizes the fund and a series of securities 124 based on these assets are created and loaned to financial institutions or services companies 126 who then grant insurance coverage, loans 130, letters of credit 132, securities or underwriting 128 using the funds securities to increase their capacity.

A risk profile can be created and a potential loss factor calculated as a component to establish the cost for a specific reverse investment fund principal or guarantee coverage. An insurer can guarantee the liquidity of the illiquid funds series and the illiquid assets placed into the trust and thereafter into the fund.

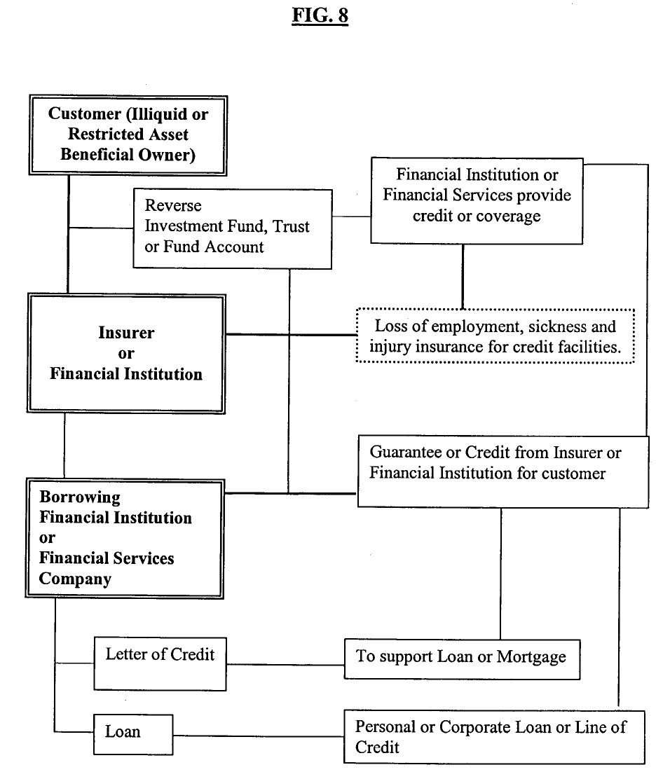

FIG. 8 illustrates another aspect of the invention. The insurer, financial institutions, services companies, or fund originator can sell related services such as loans or credit guarantees based on the assets in the reverse investment fund trust or fund account. The assets in a trust could be bankruptcy-remote and creditor-protected except for the creditor they have been pledged as collateral.

The originator can also provide insurance, income, employment, illness, injury and other coverage to these customers, based on the value placed on their individual trust or fund account, through authorized insurers and financial institutions.

Financial institution or financial services companies provide credit or coverage to trusts or fund account owners. The financial institution or financial services company borrowing the funds securities could issue a guarantee or credit for customers based on the value of the customers' reverse investment fund, trust or fund account to facilitate credit facilities or insurance coverage.

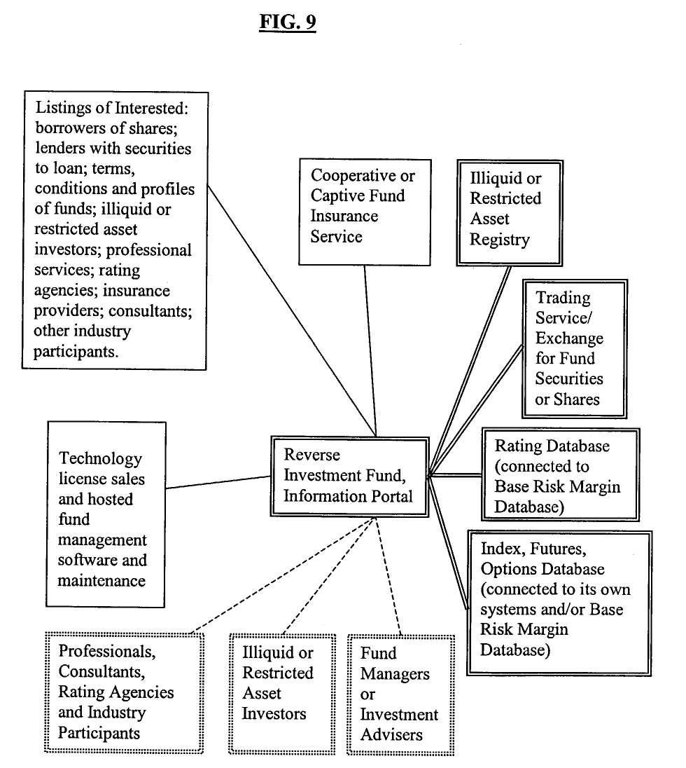

FIG. 9 illustrates the use of an information portal according to the invention. The borrowing financial institution or services company could register with the reverse investment fund information portal. This information portal would provide: an open market to find borrowers of shares; lenders with securities to loan with different terms conditions and profiles; illiquid or restricted asset investors; professional services; rating agencies; insurance providers; consultants; and related industry participants. The information portal would have different fund profiles with amounts and periods of time investments are required.

It would also provide access to a trading service or exchange for lending, borrowing and investment opportunities for the reverse investment funds securities.

The financial institution or services company will have a selection of different funds, shares or securities, based on its rating. They would also have available different types of repurchase and liquidity agreements or conditional financial instruments such as letters or credit to further support liquidity or credit enhancement for the funds shares or securities.

The information portal would provide access to the illiquid or restricted asset registry and base risk margin database. It would also provide access to cooperative or captive insurance for fund coverage requirements, sales of technology licenses with fund management software and hosting services.

The information portal would provide member and non-member access to: Fund Managers; Investment Advisers; Illiquid or Restricted Asset Investors; Professionals; Consultants; Rating Agencies; and other Industry Participants.

The illiquid or restricted assets profiles or fluids data are used for futures, options, market indexes.

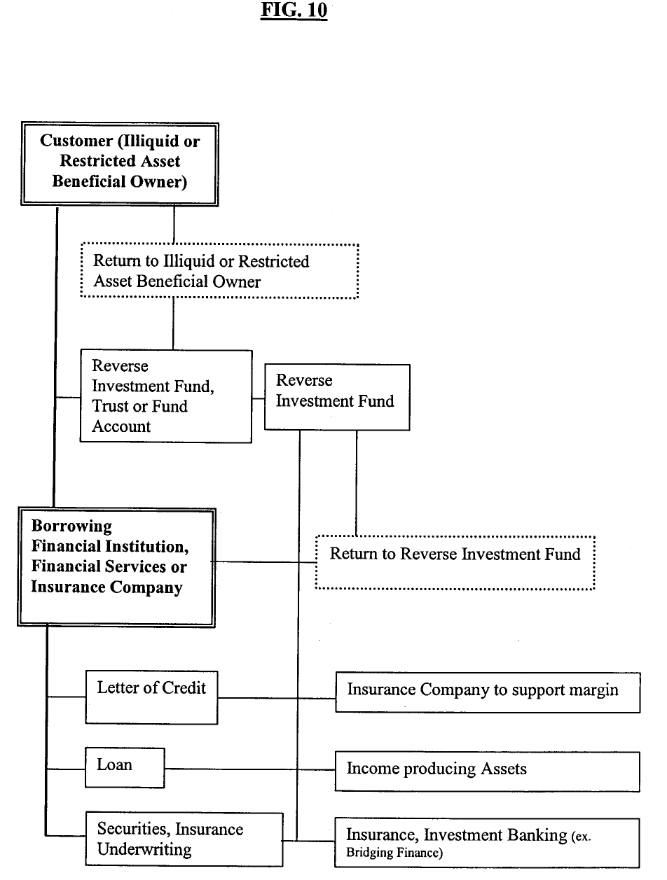

FIG. 10 illustrates the return to investors of illiquid or restricted assets. The illiquid or restricted asset owner through a trust or fund account receives a return based on the assets invested or loaned through the feeder or master reverse investment fund and the returns realized from the related lending or investment of the securities to financial institution, services company or insurer.

The reverse investment funds are designed for many different investment objectives, ranging from maximizing total return to providing the highest level of income consistent with the preservation of illiquid or restricted owner's assets. To achieve their objectives, funds invest or loan their shares or securities in a wide variety of commercial and financial services, related money market industries and programs. The reverse investment fund may require the illiquid or restricted assets through the trust or find account to be invested in the fund for a minimum period of time. It may also have additional terms and conditions for diverse investment strategies and return profiles.

The illiquid or restricted asset owner would receive a return on their assets based on their investment in the fund. If the fund itself made an annual 3.1% return on assets, and fees for the Fund Manager were 1.25%, the Originator 0.35%, the Trustee and Custodian 0.35%, and administration 0.15% then the net to the illiquid or restricted asset owner would be 1% (3.1% less 2.1% (1.25+0.35+0.35+0.15)).

The preferred embodiment of the invention has been described in some detail. However, it will be appreciated that such detail does not limit the scope of the invention itself.

What is claimed is:

1. A method of providing a return on illiquid or restricted assets comprising:
accepting a pledge or assignment of said assets from an asset owner;
investing said assets or securities based on said assets;
obtaining a return on said investment; and,
providing a return to said asset owner based on said return on said investment.

2. The method of claim 1 wherein:
a plurality of pledges or assignments are accepted from a plurality of said asset owners;
said plurality of pledges or assignments are aggregated into a fund; and,
said step of investing comprises investing securities based on of said aggregated pledges or assignments.

3. The method of claim 2 further comprising the step of issuing shares in said fund to said asset owners.

4. The method of claim 3 wherein said return to said asset owner is calculated based on the shares issued to said asset owner.

5. The method of claim 3 further comprising the step of accepting from said plurality of asset owners a pledge of said shares.

6. The method of claim 5 wherein said step of investing comprises investing said pledged shares.

7. The method of claim 2 further comprising the step of issuing securities based on the assets of said fund, said assets of said fund including said assets pledged or assigned by said asset owners.

8. The method of claim 5 further comprising the step of issuing securities based on the assets of said fund, said assets of said fund including said assets pledged or assigned by said asset owners and further including said pledged shares.

9. The method of claim 8 wherein said step of investing comprises loaning said pledged shares to a financial services company.
